(19) United States
(12) Patent Application Publication
(10) Pub. No.: US 2025/0200432 A1
(43) Pub. Date: Jun. 19, 2025

(54) MONITOR CLASS RECOMMENDATION FRAMEWORK

(71) Applicant: Microsoft Technology Licensing, LLC, Redmond, WA (US)

(72) Inventors: Anjaly PARAYIL, Bengaluru (IN); Ayush CHOURE, Bengaluru (IN); Chetan BANSAL, Seattle, WA (US); Saravanakumar RAJMOHAN, Redmond, WA (US); Pooja SRINIVAS, Bengaluru (IN); Fiza HUSAIN, Bengaluru (IN)

(73) Assignee: Microsoft Technology Licensing, LLC, Redmond, WA (US)

(21) Appl. No.: 18/593,338

(22) Filed: Mar. 1, 2024

(30) Foreign Application Priority Data
Dec. 14, 2023 (IN) 202311085339

(51) Int. Cl. G06N 20/00

(52) U.S. Cl. CPC G06N 20/00

(57) ABSTRACT

A computer-implemented method includes obtaining a training data set for multiple monitors for various services, which includes service properties and monitor metadata. The metadata for a given monitor defines resources utilized by a corresponding service. The method determines N feature vectors and a target resource class for each service based on the training data set. A machine learning model is trained in multiple training iterations using the training data set. In a given training iteration, N feature vectors of a selected service are provided to the machine learning model, which predicts a resource class of the selected service. A difference between the predicted resource class and the target resource class for the selected service is determined, based on which one or more parameters of the machine learning model can be updated. The trained machine learning model can be used to recommend a new monitor for a new service.

### CROSS-REFERENCE TO RELATED APPLICATIONS

This application claims priority to Indian Provisional Patent Application No. 202311085339, filed Dec. 14, 2023, which is incorporated herein by reference in its entirety.

### BACKGROUND

In a computing environment, services are software applications that run in the background and perform specific functions to support other applications. They are integral to the smooth operation of any system, providing important features and functionalities. Owners of services need to maintain constant vigilance over their services to ensure optimal availability and reliability. The current process of creating monitors, which can be important for this task, is often inconsistent and reactive, relying heavily on the experiential knowledge of developers and a method of trial and error. This approach can lead to gaps in coverage, resulting in operational issues, or redundancy, which can cause unnecessary disturbances and wasted resources. Therefore, a more systematic and proactive approach to monitor creation is desirable to enhance the efficiency and effectiveness of service management.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In some aspects, the techniques described herein relate to a computer-implemented method including: obtaining a training data set for a plurality of services and for a plurality of monitors for the plurality of services, wherein the training data set includes service properties for each service of the plurality of services and metadata for each monitor of the plurality of monitors, wherein the metadata for a given monitor of the plurality of monitors defines one or more resources and metrics being monitored for a corresponding service among the plurality of services; determining N feature vectors and a target monitor class for each service of the plurality of services based on the training data set, wherein N is a positive integer; and training a machine learning model in multiple training iterations using the training data set, wherein the training includes, in a given training iteration of the multiple training iterations: providing, to the machine learning model, one or more of the N feature vectors of a selected service of the plurality of services; receiving, from the machine learning model, a predicted monitor class of the selected service; determining a difference between the predicted monitor class and the target monitor class for the selected service; and updating one or more parameters of the machine learning model based at least in part on the difference.

In some aspects, the techniques described herein relate to a computing system including: memory; a processor system coupled to the memory; and one or more computer readable storage media storing instructions that, when loaded into the memory, cause the processor system to perform operations including: receiving service properties of a new service; determining N feature vectors for the new service based on the service properties of the new service, wherein N is a positive integer; providing the N feature vectors for the new service to a trained machine learning model; and predicting a monitor class to be included in a monitor for the new service using the trained machine learning model.

In some aspects, the techniques described herein relate to one or more computer-readable media having encoded thereon computer-executable instructions causing one or more processors to perform a method, the method including: obtaining a training data set for a plurality of services and for a plurality of monitors for the plurality of services, wherein the training data set includes service properties for each service of the plurality of services and metadata for each monitor of the plurality of monitors, wherein the metadata for a given monitor of the plurality of monitors defines one or more resources and metrics being monitored for a corresponding service among the plurality of services; determining N feature vectors and a target monitor class for each service of the plurality of services based on the training data set, wherein N is a positive integer; training a machine learning model in multiple training iterations using the training data set, wherein the training includes, in a given training iteration of the multiple training iterations: providing, to the machine learning model, one or more of the N feature vectors of a selected service of the plurality of services; receiving, from the machine learning model, a predicted monitor class of the selected service; determining a difference between the predicted monitor class and the target monitor class for the selected service; and updating one or more parameters of the machine learning model based at least in part on the difference; and recommending a new monitor for a new service using the trained machine learning model, wherein the recommending includes: determining N feature vectors for the new service; providing the N feature vectors for the new service to the trained machine learning model; and predicting a monitor class to be included in the new monitor using the trained machine learning model.

As described herein, a variety of other features and advantages can be incorporated into the technologies as desired.

### BRIEF DESCRIPTION OF THE DRAWINGS

FIG. 1 is an overall block diagram of an example computing system implementing an intelligent monitor class recommendation framework.

FIG. 2 is a block diagram illustrating an example process of generating a structured ontology from metadata of monitors.

FIG. 3 is an architecture diagram of an example large language model.

FIG. 4 is an example block diagram of a recommendation engine that can be used in the intelligent monitor class recommendation framework of FIG. 1.

FIG. 5 is a flowchart illustrating an example overall method for training a machine learning model to recommend monitor classes for a service.

FIG. 6 is a flowchart illustrating an example overall method for using a trained machine learning model to recommend a monitor class for a service.

FIG. 7 is a block diagram of an example computing system in which described embodiments can be implemented.

FIG. 8 is a block diagram of an example cloud computing environment that can be used in conjunction with the technologies described herein.

### DETAILED DESCRIPTION

### Overview of Service Monitors

In various computing environments, a multitude of services are deployed and utilized by a vast number of users. For example, a hyper-scale cloud environment can deploy thousands of services across multiple geographical regions and used by hundreds of millions of users. As another example, in enterprise data centers, various services such as database management, application hosting, and network security can be deployed and used by thousands of employees within the organization. Similarly, Internet Service Providers (ISPs) can deploy numerous services including broadband, voice over internet protocol (VoIP), and mobile services that are used by millions of subscribers. Even in a monolithic computing environment, a multitude of services can be deployed and utilized by a vast number of users. For example, enterprise resource planning (ERP) software can be a comprehensive suite of applications that integrates and manages different parts of a business, and it can be used by thousands of employees within an organization to streamline various processes. As another example, in a production facility, services can be operations of equipment. As still another example, in a vehicle, services can be operations of modular systems of the vehicle. In any of the examples described herein, the deployed services can be microservices, which are small, independently deployable, and loosely coupled software applications that perform specific functions within a larger enterprise application.

The continuous availability of these services can be crucial for maintaining customer satisfaction and generating business revenue. Despite substantial efforts to ensure reliability, production incidents or failures are inevitable. These incidents can have a negative impact on customers and necessitate significant engineering resources and manual effort for mitigation. As such, early detection and mitigation of incidents can be important to minimize customer impact and reduce associated costs. Typically, service providers use monitors, which are specifically designed software tools, to continuously track the health and performance of deployed services, enabling early detection and mitigation of incidents.

As described herein, the terms “monitors” and “services” are not limited to any specific usage scenarios. For example, the services can be computing services, and the monitors can be service monitors on those computing services. As another example, the services can be operations of components of a computing device, and the monitors can be component monitors configured to monitor operations of the components of the computing device. In yet another example, the services can be operations of equipment at a factory or other production facility, and the monitors can be equipment monitors configured to monitor operations of the equipment or other production facility. As a further example, the services can be operations of modular systems of a vehicle, and the monitors can be system monitors configured to monitor operations of the modular systems of the vehicle.

However, the current process for creating monitors, which is largely based on trial and error, often falls short of effectiveness. For instance, a service provider might overlook the need for a critical monitor that tracks database latency, only realizing its importance when a latency-related incident occurs. This reactive approach can lead to unforeseen challenges and inefficiencies, hindering the overall performance and reliability of the system. On the other hand, redundant monitors, such as multiple monitors tracking CPU usage, can create a cacophony of alerts, obscuring truly critical issues amidst the noise (e.g., alerts that are unnecessary, inappropriate, and/or incorrect). This not only wastes engineering resources in sifting through irrelevant alerts but also delays the mitigation of real incidents.

The technologies described herein overcome many of the technical challenges described above. Specifically, disclosed herein is an intelligent monitor class recommendation framework which provides a more strategic and proactive approach for the creation and management of service monitors. By leveraging the disclosed monitor class recommendation framework, service providers can ensure that their monitoring practices are consistent, efficient, and effective.

### Example Terms

In the context of a service ecosystem, the following terms are introduced to facilitate description of the disclosed technologies.

A resource is an entity that could potentially be the source of a critical issue for a service. Resources could be internal to a service's environment, such as CPU, Paging Cache, Stack Size, etc., or external dependencies like databases and cloud storage. Resources can be denoted by r.

A functionality group, denoted by F, is a collection of various individual resources. For instance, a specific Virtual Machine (VM) can be a functionality group that includes multiple resources like CPU, RAM, and storage. Each functionality group F can be expanded into a set of resources, r(F)={rᵢ}.

A metric, denoted by m, is a time-series object generated as resources are utilized. The metric is always associated with a resource, and a mathematical expression implicitly defines its members. A common example of a metric is the CPU utilization on a machine hosting the service VM. For a given metric m, the corresponding resource can be represented as rm. In some examples, a metric can also be referred to as a performance objective (PO), alternatively called a service level objective (SLO). As described herein, the PO is a generic term broadly encompasses any metrics that measures the performance, efficiency, reliability, among other aspects, of a service.

Alerting logic refers to the anomaly detection rules that operate on metrics and serve as triggers for generating alerts. For instance, an alert would be triggered if the CPU utilization exceeds 90% for the last 30 time steps, indicating a potential CPU bottleneck. Each rule can be associated with a severity level. The alerting logic statements are always linked to a specific metric. Individual alerting logic statements can be denoted by the symbol A. The corresponding metric and resource can be represented as m_{A} and r_{A}, respectively.

A monitor, denoted by M, is defined as a collection of triplets consisting of a resource, metric, and alerting logic. A monitor triggers an alert of a specific severity if an alerting logic (of the same severity) is activated. The components of an individual monitor can be represented as {rᵢ, mᵢ, Aᵢ} for 1<i<k, where a given M is a collection of k individual alerting logic statements.

As described above, a functionality group F serves as a container for a collection of individual resources, which can be identified by the metrics generated from time-series measurements on them. In some cases, although the functionality group may encompass various types of resources, only a subset of these, which are critical from a runtime issues perspective and have observable metrics recorded, are of interest. In some examples, when training a neural network for monitor class recommendation, as described more fully below, only those resources that are already under some metric measurements are collected as part of a training data set.

An individual service can be denoted as S. For simplicity, the notations can be overloaded so that these symbols are used as unimodal operators to transition from one category to another, where applicable. For instance, M(S) represents the set of all monitors associated with S, and m(M) denotes the set of all metrics associated with a monitor M.

Each service can have a plurality of service properties. Service properties can include dependencies and components. Dependencies define the interrelationships between different services. Example dependencies include data analytic service, data store, infrastructure management service, etc. These dependencies can be further categorized into upstream and downstream dependencies. Upstream dependencies are those that a particular service depends on for its operation. These could be other services, databases, or other infrastructure components that provide necessary data or functionality. On the other hand, downstream dependencies are those that rely on the given service, consuming its outputs for their operation. This consumption could be in the form of data, processed information, or any other form of output that the service provides. In some examples, the dependencies between services can be represented by a hierarchical dependency tree.

A service, in the context of software architecture, is composed of various components that can be categorized as either physical or logical. Physical components are tangible entities that provide the necessary infrastructure for the service to operate. These include, but are not limited to, elements like facilities, which house the servers and storage devices; clusters, which are groups of linked servers; and virtual machines (VMs), which are emulations of computer systems. On the other hand, logical components are abstract entities that define the behavior and interaction of the service. These include, but are not limited to, roles, which specify the responsibilities and permissions of a component within the service; environments, which provide the settings in which the service operates; tenants, which represent the different users or user groups that can access the service; and stamps, which are instances of a service deployment.

Monitor classes include resource classes and PO classes. Resource classes, denoted as C, are broad categories of resources typically utilized by services. Example resource classes include CPU, RAM, Storage, APIs, etc. For a given data set, a suitable list of resource classes can be defined to cover a significant proportion (e.g., >95%, >85%, etc.) of the resources in the data set. An operator can be overloaded to denote association. For example, C(r) can represent the resource class of the resource r, and C(F) can denote the set of resource classes of the resources included in F. Similarly, various metrics can be categorized into a limited number of PO classes. Example PO classes include latency, throughput, error/success rate, etc. For a given data set, a suitable list of PO classes can be defined to cover a significant proportion (e.g., >95%, >85%, etc.) of the POs in the data set.

### Example Monitor Classes

The particular resources utilized by various services can be task-specific and/or platform-specific, and particular POs that need to be monitored can also vary significantly based on tasks and/or environments. Although the granularity and volume of resources and POs (which can be thousands or more) make predicting exact resources and POs for a specific service very difficult, such exact predictions may be unnecessary. Instead of recommending monitors for a given service with specific resources and POs, the problem can be reframed with a more tractable but equally valuable question: for a given service with specific service properties, what monitor classes should be monitored? Such a reframed problem is more manageable because the resource classes and PO classes can be predefined. The solution to this reframed problem is also valuable because the limited number of monitor classes can cover a significant portion of the resources and POs used in practice.

The following lists some exemplary, but non-exclusive, resource classes that cover a majority of resources typically utilized by various services (note that the labels of the resource classes can be varied or custom defined).

Service-level class include resources that are specific to an individual service. Examples include feature components offered by a service that other services can use, internal components such as functions or pipelines, etc.

Application programming interface (API) is another typical resource class for a service. API is used to access data, functionality, or services provided by another software application or service.

Dependency class represents the external services and components that a service relies on for its proper functioning. Dependencies can include other services, databases, messaging systems, and other infrastructure components.

CPU resource class refers to the compute bandwidth available on a cluster node. It is typically monitored in real-time, and alerts are generated if the CPU usage exceeds certain thresholds.

Compute cluster class provides the computing power needed to run applications and services. It is typically composed of multiple VMs or instances that can be provisioned and scaled on demand. Monitoring a compute cluster involves tracking its performance, availability, and utilization.

Storage resource class represents the physical and virtual storage devices used by the service to store data. Monitoring the storage resource class can help identify any issues with the storage devices or the storage infrastructure, such as disk failures, data corruption, or insufficient storage capacity.

Ram-memory resource class represents the available volatile memory, such as random-access memory (RAM). Apart from the fact that insufficient memory can lead to slow response times or even service crashes, active monitoring of RAM usage can help identify any memory leaks or inefficient memory usage patterns.

Cache-memory resource class represents a type of highspeed memory used by a service to store frequently accessed data or instructions. Monitoring the cache memory usage can help identify any cache misses, freshness issues or inefficient cache usage patterns.

Containers provide a mechanism which can be used for deploying and running applications in a cloud environment, as they can be easily moved across different computing environments without requiring any changes to the underlying code. Containers act as encapsulations of resources and functionalities and can be thought as the most granular independently hostable unit. They are typically monitored for availability.

Certificates can be often used to secure communication channels and authenticate users, and guarantee compliance. Monitoring certificates includes tracking expiration dates, certificate revocation lists, and usage patterns.

Input/output (IO) is also a machine level resource (like CPU and RAM) and covers machine level data bandwidth. Its monitoring can be important to ensure that data is being transferred efficiently and without errors, as well as to detect and diagnose any performance issues that may be impacting the overall performance of a service.

Paging memory monitoring is important to ensure that paging operations are occurring efficiently and without errors. This includes monitoring paging rates, page faults, and other metrics related to memory usage and performance.

Any resources that are not covered in the above listed classes can be captured in a catch-all class “None-of-the-above”. Examples from this class include job execution, data sovereignty, network, etc.

The following lists some exemplary, but non-exclusive, PO classes that cover most of metrics typically measured by monitors for various resources (note that the labels of the PO classes can be varied or custom defined).

Success rate class measures the number of successful events divided by the number of total events. For instance, “99.99% of requests in the last 5 minutes were successful.” It is a commonly used measurement type across many monitors.

Capacity class can be categorized into two types based on the availability of capacity. Both types measure the number of responses that are throttled. The first type counts erroneous responses when capacity is available but incorrectly reported as unavailable. The second type represents a genuine failure to meet customer expectations due to a lack of capacity. In both scenarios, the focus is on quantifying the impact of capacity-related issues on service delivery.

Latency class is the amount of time elapsed between when a request for an operation is made and when the invoker can make use of the returned result.

Availability class, from the perspective of a customer utilizing the service, quantifies the service's uptime and is typically measured in percentages. While similar to Success Rate class, Availability class differs in that it does not validate whether the returned results align with the expectations set by the requests. Instead, it simply ensures that results are being delivered to the user.

Throughput class measures a minimum data transfer rate over a time window, e.g., expressed in kilobytes per second. Throughput class can have highly variable time windows, dependent on the user expectation for when data transfer should finalize.

Success rate—QoS class focuses on the quality of successful event. It measures whether the service is performing as expected, e.g., reliability of a page rendered by the front end of a web application.

Interruption Rate class measures the rate of specific type of interruptive events on specific resource (e.g., the number of VM reboots).

Freshness class measures the timeliness of data or information in the context of data processing or data streaming systems. The goal is to ensure that data or information is delivered or processed within a certain time frame. Freshness class can be defined in different ways, such as the maximum age of data or information that is acceptable, or the maximum delay between the time when data or information is produced and the time when it is processed or delivered.

Any metrics that are not covered in the above major classes can be denoted by the class “Others.” Examples from this class include compliance failures, privacy issues, etc.

### Example Computing System for Intelligent Monitor Class Recommendation

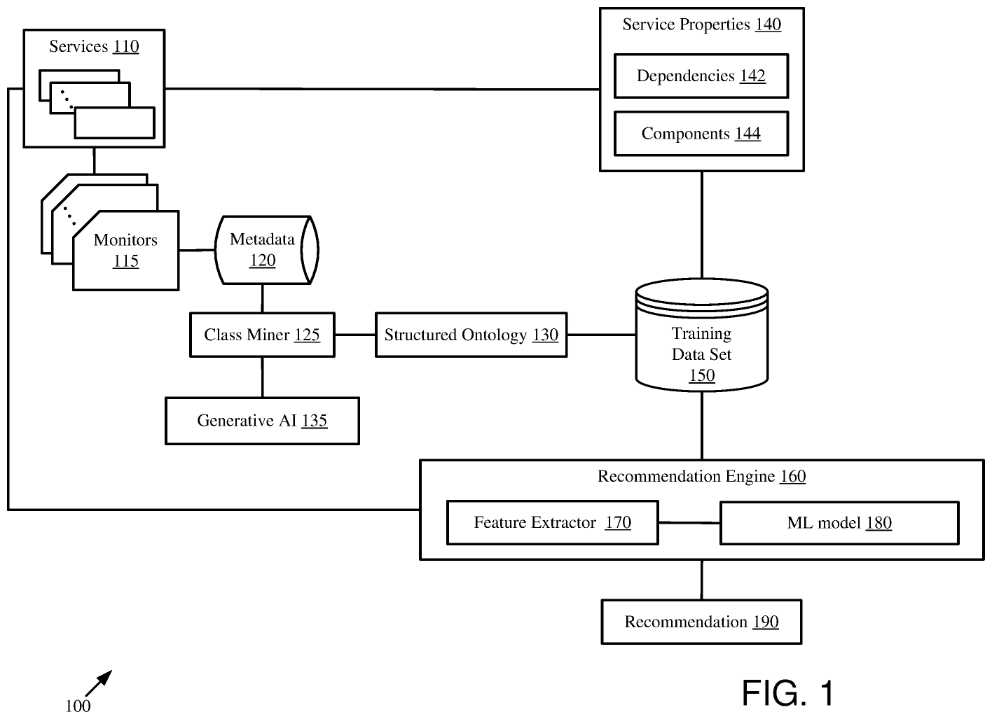

FIG. 1 shows an overall block diagram of an example computing system 100 implementing an intelligent monitor class recommendation framework. The intelligent monitor class recommendation framework can be used to determine two major dimensions of the monitors; resource classes (what to monitor within a service) and PO classes (which metrics are most representative of the performance, efficiency, and reliability of a service).

The intelligent monitor class recommendation framework described herein involves training a machine learning (ML) model using a training data set collected from a cohort of services and existing monitors specifically designed for those services. Once properly trained, the ML model can be used to recommend monitor classes (e.g., resource classes, etc.) for a new service, or suggest missing monitor classes for an existing service.

As shown in FIG. 1, a plurality of services 110 can be associated with a plurality of monitors 115 configured to monitor the health and performance of the services 110. In some examples, a service can have only one corresponding monitor. In some examples, a service can have two or more corresponding monitors.

Service properties 140 can be collected from each of the services 110. Service properties 140 can include dependencies 142 and components 144. As described above, dependencies 142 can include upstream and downstream dependencies, and the components can include physical and logical components.

Metadata 120 can be collected from each of the monitors 115. The metadata for a given monitor can define one or more resources utilized by a corresponding service. The metadata for a given monitor can also define one or more metrics corresponding to or measuring the one or more resources. Additionally, the metadata for a given monitor can include instances of alerting logic that define alert triggering conditions.

A class miner 125 can be used to mine the collected metadata 120 to generate a structured ontology 130. The structured ontology 130 can map the resources and metrics contained in the metadata 120 into respective resource classes and PO classes. As described more fully below, such data mining and mapping can be facilitated by interfacing with a generative artificial intelligence (AI) model 135.

The service properties 140 collected from the services 110, along with the structured ontology 130 generated from metadata 120 of the monitors 115, can collectively form a training data set 150, which can be provided to a recommendation engine 160.

The recommendation engine 160 can have a feature extractor 170 and a ML model 180. The feature extractor 170 can be configured to extract feature vectors from the training data set 150. As described more fully below, the extracted feature vectors can represent similarities between services and associated monitor classes. The extracted feature vectors and labels of monitor classes (ground truth) can be used to train the ML model 180 in an iterative manner.

After the training is completed, the ML model 180 is ready to perform inference and generate a recommendation 190 of monitor(s) for a service. This service could either be a new one, which has not been used in the training, or an existing one, which has been part of the training process. In the case of a new service, the inference-driven recommendation 190 can propose which monitor classes ought to be incorporated into the monitor(s) for this new service. For an existing service, the recommendation 190, based on inference, can suggest which monitor classes are absent from the current monitor(s) and therefore should be added to enhance the service.

In practice, the systems shown herein, such as the computing system 100, can vary in complexity, with additional functionality, more complex components, and the like. For example, there can be additional functionality within the recommendation engine 160. Additional components can be included to implement security, redundancy, load balancing, report design, data logging, and the like.

The described computing systems can be networked via wired or wireless network connections, including the Internet. Alternatively, systems can be connected through an intranet connection (e.g., in a corporate environment, government environment, or the like).

The computing system 100 and any of the other systems described herein can be implemented in conjunction with any of the hardware components described herein, such as the computing systems described below (e.g., processing units, memory, and the like). In any of the examples herein, service properties, metadata, resources, metrics, monitor classes, feature vectors, and the like can be stored in one or more computer-readable storage media or computer-readable storage devices. The technologies described herein can be generic to the specifics of operating systems or hardware and can be applied in any variety of environments to take advantage of the described features.

### Example Overview of Process for Generating Structured Ontology

As described above, the metadata (e.g., the metadata 120) for a given monitor can define resources utilized by a corresponding service, metrics corresponding to or measuring the resources, and instances of alerting logic that define alert triggering conditions. A class miner (e.g., the class miner 125) can be used to mine the collected metadata to generate a structured ontology (e.g., the structured ontology 130), which can map the resources and metrics contained in the metadata into respective resource classes and PO classes.

Using standard natural language processing (NLP) techniques to extract ontology structure from metadata of monitors can be challenging due to several reasons. First, the metadata often contains highly domain-specific terminology and concepts, which may not be well-understood by general-purpose NLP models. Additionally, the relationships between different elements in the metadata (such as resources, metrics, and instances of alerting logic) can be complex and not easily captured by standard NLP techniques. Further, the metadata may contain a lot of noise, such as irrelevant information or inconsistencies, which can make the extraction process more difficult.

Described herein is a technique which leverages generative AI to extract structured ontology from the metadata of monitors. In contrast to discriminative AI which aim to make decisions or predictions based on features of the input data, generative AI is a type of AI that can create content, such as text, images, or even code. A large language model (LLM) is a type of generative AI that can understand and generate human-like text, while multi-model generative AI extends this capability to generate a variety of media types, including text, images, audio, video, etc., allowing for more diverse and versatile content creation. In generative AI, such as LLMs, a prompt serves as an input or instruction that informs the AI of the desired content, context, or task, allowing users to guide the AI's text generation to produce tailored responses, explanations, or creative content based on the provided prompt.

The process of generating structured ontology from metadata of monitors begins by using the generative AI to analyze the triplet data of functionality, metric, and alerting logic, and generate descriptions of what the monitors are actually doing. This creates an augmented dataset of quadruples, adding a text description of the specific triplet's functionality from a resource and metric perspective. However, these descriptions still contained a lot of environment and service signals, which can influence the clustering of the data. To mitigate this, the generative AI can be used again to label the data points directly using a predefined list of resource classes and PO classes, instead of relying on NLP-based clustering. The predefined resource classes and PO classes can be created incrementally through manual review of a randomized sample of the quadruple data collected from metadata of existing monitors. This approach allowed for the extraction of structured ontology from the metadata of monitors, providing valuable insights into their functionality.

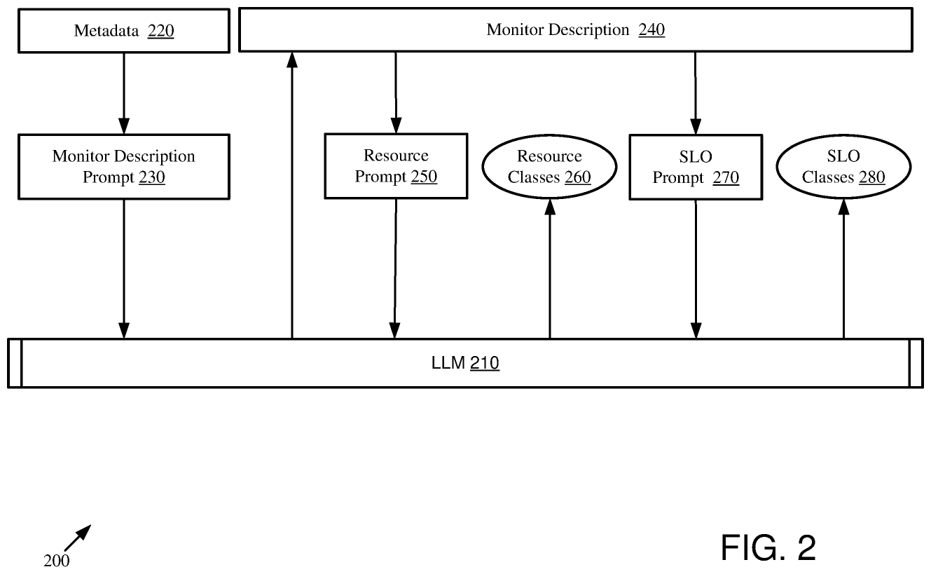

FIG. 2 is a block diagram illustrating an example process or method 200 of generating a structured ontology from metadata of monitors by using an LLM 210. In any of the examples herein, an LLM can take the form of an AI model that is designed to understand and generate human language. Such models typically leverage deep learning techniques such as transformer-based architectures to process language with a very large number (e.g., billions) of parameters. Examples include the Generative Pre-trained Transformer (GPT) developed by OpenAI, Bidirectional Encoder Representations from Transforms (BERT) by Google, A Robustly Optimized BERT Pretraining Approach developed by Facebook AI, Megatron-LM of NVIDIA, or the like. Pretrained models are available from a variety of sources.

In any of the examples herein, prompts can be provided to LLMs to generate responses. Prompts in LLMs can be initial input instructions that guide model behavior. Prompts can be textual cues, questions, or statements that users provide to elicit desired responses from the LLMs. Prompts can act as primers for the model's generative process. Sources of prompts can include user-generated queries, predefined templates, or system-generated suggestions. Technically, prompts are tokenized and embedded into the model's input sequence, serving as conditioning signals for subsequent text generation. Users can experiment with prompt variations to manipulate output, using techniques like prefixing, temperature control, top-K sampling, etc. These prompts, sourced from diverse inputs and tailored strategies, enable users to influence LLM-generated content by shaping the underlying context and guiding the neural network's language generation. For example, prompts can include instructions and/or examples to encourage the LLMs to provide results in a desired style and/or format.

### Example Prompts and LLM Output

As shown in FIG. 2, metadata 220 of a given monitor can be submitted to the LLM 210, along with a monitor description prompt 230, which is configured to prompt the LLM 210 to generate a functional description of the given monitor based on the metadata 220. An example monitor description prompt 230 can be “User: What do you think the monitor does? Monitor Metadata: { . . . }”, wherein the ellipsis represents the actual metadata of the given monitor being inserted into the curly brackets. In response to the received monitor description prompt 230, the LLM 210 can output a monitor description 240 as a reply or response.

As an example, metadata of a monitor can be:

Service level - {“Monitor name”: “BotComponentTerminationException”, “Account
name”: “MCR_RunTime_Performance”, “namespace”: “MCR_QoS”, “Metric name”:
“bot_component_call_terminate_exception”, “Sampling type”: “Sum”, “Alert title”:
“{Monitor.DisplayName }-
{Monitor.Dimension.cloud}.{ Monitor.Dimension.ring}.{Monitor. Dimension.region}.
{Monitor.Dimension.partition}.{Monitor.Dimension.location }_Error:{ Monitor.Dimension.
exception_type }-IsTestTraffic:{Monitor.Dimension.IsTestTraffic}”, “Service Name”:
“Media Composition Runtime”}

In response to the monitor description prompt, the LLM 210 can generate the following monitor description:

This monitor is likely used to detect unexpected terminations of bot components in the
Media Composition Runtime (MCR) service. It collects data related to the Account
name, namespace, metric name, sampling type, and alert title, which can then be used to
monitor and alert on any unexpected terminations. The alert title is constructed from the
monitor's display name, dimensions related to the cloud, ring, region, partition, and
location, exception type, and IsTestTraffic.

The monitor description 240 can be provided to the LLM 210 (or submitted a different LLM) with additional prompts to generate monitor classes which become part of the structured ontology. Specifically, the monitor description 240 can be included in a resource prompt 250 submitted to the LLM 210. The resource prompt 250 can be configured to prompt the LLM 210 to output one or more resource classes 260 based on the monitor description 240. In other words, the LLM 210 can categorize the resources defined in the metadata 220 into one or more resource classes 260, which can be selected from a list of predefined resource classes described above. Further, the monitor description 240 can be included in a PO prompt 270 submitted to the LLM 210. The PO prompt 270 can be configured to prompt the LLM 210 to generate one or more PO classes 280 based on the monitor description 240. In other words, the LLM 210 can categorize the metrics defined in the metadata 220 into one or more PO classes 280, which can be selected from a list of predefined PO classes described above.

An example resource prompt can be:

User: You are an intelligent virtual assistant that answers questions from a user based on
the monitor metadata and description provided { . . . }. Go through the description and
monitor metadata. Preprocess the text such as camel casing, snake case splitting, etc.
And answer the following questions sequentially. Q1: A monitor either tracks
functionality of components associated with the service such as features offered by it to
other services or users, internal functions or pipelines or it's dependencies such
datastores, or tracks some performance objectives guaranteed by the service. And
generally, an intelligent assistant can deduce the entity being tracked by a monitor from
the monitor description. What do you think is the underlying entity being tracked by this
monitor? Q2: Categorize the entity being tracked by the monitor to a generic class: 1.
API, 2. dependency, 3. compute cluster, 4. service level, 5.CPU cache-memory, 6. ram-
memory, 7. CPU, 8. paging memory, 9. container, 10. IO, 11. Storage, 12. none-of-the-
above.

In this prompt, the ellipsis enclosed within the curly brackets represents the example monitor description noted above. In response to the resource prompt, the LLM 210 can generate a response, e.g., indicating that “service level” is the resource class representing resources defined in the metadata 220.

An example PO prompt can be:

User: You are an intelligent virtual assistant that answers questions from a user based on
the monitor description and metadata provided { . . . }. User: Go through the description
and metadata. Preprocess the text such as camel casing, snake case splitting, etc. And
answer the following questions sequentially. Q1: A monitor tracks some performance
objectives guaranteed by the service. A performance object is numeric goal that is
defined for a metric emitted by a service. This metrics associated with this goal can be
monitored to determine whether the service is healthy. Generally, an intelligent assistant
can deduce the performance objective tracked by a monitor from the monitor description.
What do you think is the performance objective tracked by this monitor? Provide
justifications for your output? Q2: Categorize the performance objective being tracked
by the monitor to a generic class: 1. Availability, 2. Latency, 3. Capacity, 4. Throughput,
5. Success Rate, 6. Interruption Rate, 7. Freshness, 8. Others.

In this prompt, the ellipsis enclosed within the curly brackets represents the example monitor description noted above. In response to the PO prompt, the LLM 210 can generate a response, e.g., indicating that “Success Rate” is the PO class representing metrics defined in the metadata 220.

For each monitor, the metadata is analyzed using the process or method 200 to obtain corresponding monitor classes (e.g., resource classes and PO classes). A collection of monitor classes obtained from a plurality of monitors for a plurality of services can define a structured ontology corresponding to the plurality of monitors for the plurality of services. Thus, when the structured ontology is provided as part of the training data set (e.g., the training data set 150) for training a recommendation engine (e.g., the recommendation engine 160), the monitor classes associated with a given monitor for a given service can be used as labels or ground truth for the given service, as described further below.

In some circumstances, statistics of and/or correlation between the monitor classes obtained from the plurality of monitors can be analyzed, e.g., to determine a distribution of a set of monitor classes among the plurality of monitors, to determine a distribution of a set of PO classes among different resource classes, to determine coexistence tendency among resource classes, etc. Such statistical or correlation analysis can offer valuable insights that enhance monitor recommendations. For instance, if the analysis reveals that the distribution of PO classes varies across resource classes, it might suggest a limited set of PO classes to consider for each resource class. Consequently, predicting a service's PO classes could be achieved by examining its associated resource classes. As another example, if the presence of a particular resource class within a service suggests the probable existence of another resource class, this coexistence signal could be used to recommend additional monitors. These monitors could be particularly useful for tracking certain missing resource classes within an existing service.

### Example Architecture of LLM

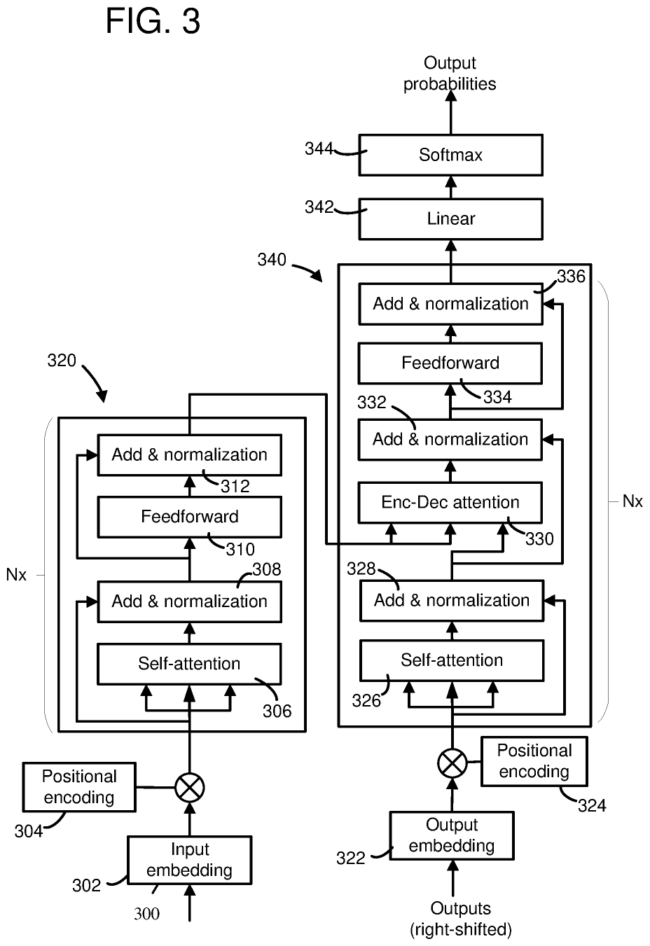

FIG. 3 shows an example architecture of an LLM 300, which can be used as the LLM 210 of FIG. 2 or the generative AI model 135 of FIG. 1.

In the depicted example, the LLM 300 uses an autoregressive model (as implemented in OpenAI's GPT) to generate text content by predicting the next word in a sequence given the previous words. The LLM 300 can be trained to maximize the likelihood of each word in the training dataset, given its context.

As shown in FIG. 3, the LLM 300 can have an encoder 320 and a decoder 340, the combination of which can be referred to as a “transformer.” The encoder 320 processes input text, transforming it into a context-rich representation. The decoder 340 takes this representation and generates text output.

For autoregressive text generation, the LLM 300 generates text in order (e.g., from left to right), and for each word it generates, it relies on the preceding words for context. During training, the target or output sequence, which the model is learning to generate, is presented to the decoder 340. However, the output is right shifted by one position compared to what the decoder 340 has generated so far. In other words, the model sees the context of the previous words and is tasked with predicting the next word. As a result, the LLM 300 can learn to generate text in a left-to-right manner, which is how language is typically constructed.

Text inputs to the encoder 320 can be preprocessed through an input embedding unit 302. Specifically, the input embedding unit 302 can tokenize a text input into a sequence of tokens, each of which represents a word or part of a word. Each token can then be mapped to a fixed-length vector known as an input embedding, which provides a continuous representation that captures the meaning and context of the text input. Likewise, to train the LLM 300, the targets or output sequences presented to the decoder 340 can be preprocessed through an output embedding unit 322. Like the input embedding unit 302, the output embedding unit 322 can provide a continuous representation, or output embedding, for each token in the output sequences.

Generally, the vocabulary in LLM 300 is fixed and is derived from the training data. The vocabulary in LLM 300 consists of tokens generated above during the training process. Words not in the vocabulary cannot be output. These tokens are strung together to form sentences in the text output.

In some examples, positional encodings (e.g., 304 and 324) can be performed to provide sequential order information of tokens generated by the input embedding unit 302 and output embedding unit 322, respectively. Positional encoding is needed because the transformer, unlike recurrent neural networks, process all tokens in parallel and do not inherently capture the order of tokens. Without positional encoding, the model would treat a sentence as a collection of words, losing the context provided by the order of words. Positional encoding can be performed by mapping each position/index in a sequence to a unique vector, which is then added to the corresponding vector of input embedding or output embedding. By adding positional encoding to the input embedding, the model can understand the relative positions of words in a sentence. Similarly, by adding positional encoding to the output encoding, the model can maintain the order of words when generating text output.

Each of the encoder 320 and decoder 340 can include multiple stacked or repeated layers (denoted by Nx in FIG. 3). The number of stacked layers in the encoder 320 and/or decoder 340 can vary depending on the specific LLM architecture. Generally, a higher “N” typically means a deeper model, which can capture more complex patterns and dependencies in the data but may require more computational resources for training and inference. In some examples, the number of stacked layers in the encoder 320 can be the same as the number of stacked layers in the decoder 340. In other examples, the LLM 300 can be configured so that the encoder 320 and decoder 340 can have different numbers of layers. For example, a deeper encoder (more layers) can be used to better capture the input text's complexities while a shallower decoder (fewer layers) can be used if the output generation task is less complex).

The encoder 320 and the decoder 340 are related through shared embeddings and attention mechanisms, which allow the decoder 340 to access the contextual information generated by the encoder 320, enabling the LLM 300 to generate coherent and contextually accurate responses. In other words, the output of the encoder 320 can serve as a foundation upon which the decoder network can build the generated text.

Both the encoder 320 and decoder 340 comprise multiple layers of attention and feedforward neural networks. An attention neural network can implement an “attention” mechanism by calculating the relevance or importance of different words or tokens within an input sequence to a given word or token in an output sequence, enabling the model to focus on contextually relevant information while generating text. In other words, the attention neural network pays “attention” to certain parts of a sentence that are most relevant to the task of generating text output. A feedforward neural network can process and transform the information captured by the attention mechanism, applying non-linear transformations to the contextual embeddings of tokens, enabling the model to learn complex relationships in the data and generate more contextually accurate and expressive text.

In the example depicted in FIG. 3, the encoder 320 includes an intra-attention or self-attention neural network 306 and a feedforward neural network 310, and the decoder 340 includes a self-attention neural network 326 and a feedforward neural network 334. The self-attention neural networks 306, 326 allow the LLM 300 to weigh the importance of different words or tokens within the same input sequence (self-attention in the encoder 320) and between the input and output sequences (self-attention in the decoder 340), respectively.

In addition, the decoder 340 also includes an inter-attention or encoder-decoder attention neural network 330, which receives input from the output of the encoder 320. The encoder-decoder attention neural network 330 allows the decoder 340 to focus on relevant parts of the input sequence (output of the encoder 320) while generating the output sequence. As described below, the output of the encoder 320 is a continuous representation or embedding of the input sequence. By feeding the output of the encoder 320 to the encoder-decoder attention neural network 330, the contextual information and relationships captured in the input sequence (by the encoder 320) can be carried to the decoder 340. Such connection enables the decoder 340 to access to the entire input sequence, rather than just the last hidden state. Because the decoder 340 can attend to all words in the input sequence, the input information can be aligned with the generation of output to improve contextual accuracy of the generated text output.

In some examples, one or more of the attention neural networks (e.g., 306, 326, 330) can be configured to implement a single-head attention mechanism, by which the model can capture relationships between words in an input sequence by assigning attention weights to each word based on its relevance to a target word. The term “single-head” indicates that there is only one set of attention weights or one mechanism for capturing relationships between words in the input sequence. In some examples, one or more of the attention neural networks (e.g., 306, 326, 330) can be configured to implement a multi-head attention mechanism, by which multiple sets of attention weights, or “heads,” in parallel to capture different aspects of the input sequence. Each head learns distinct relationships and dependencies within the input sequence. These multiple attention heads can enhance the model's ability to attend to various features and patterns, enabling it to understand complex, multi-faceted contexts, thereby leading to more accurate and contextually relevant text generation. The outputs from multiple heads can be concatenated or linearly combined to produce a final attention output.

As depicted in FIG. 3, both the encoder 320 and the decoder 340 can include one or more addition and normalization layers (e.g., the layers 308 and 312 in the encoder 320, the layers 328, 332, and 336 in the decoder 340). The addition layer, also known as a residual connection, can add the output of another layer (e.g., an attention neural network or a feedforward network) to its input. After the addition operation, a normalization operation can be performed by a corresponding normalization layer, which normalizes the features (e.g., making the features to have zero mean and unit variance). This can help in stabilizing the learning process and reducing training time.

A linear layer 342 at the output end of the decoder 340 can transform the output embeddings into the original input space. Specifically, the output embeddings produced by the decoder 340 are forwarded to the linear layer 342, which can transform the high-dimensional output embeddings into a space where each dimension corresponds to a word in the vocabulary of the LLM 300.

The output of the linear layer 342 can be fed to a softmax layer 344, which is configured to implement a softmax function, also known as softargmax or normalized exponential function, which is a generalization of the logistic function that compresses values into a given range. Specifically, the softmax layer 344 takes the output from the linear layer 342 (also known as logits) and transforms them into probabilities. These probabilities sum up to 1, and each probability corresponds to the likelihood of a particular word being the next word in the sequence. Typically, the word with the highest probability can be selected as the next word in the generated text output.

Still referring to FIG. 3, the general operation process for the LLM 300 to generate a reply or text output in response to a received prompt input is described below.

First, the input text is tokenized, e.g., by the input embedding unit 302, into a sequence of tokens, each representing a word or part of a word. Each token is then mapped to a fixed-length vector or input embedding. Then, positional encoding 304 is added to the input embeddings to retain information regarding the order of words in the input text.

Next, the input embeddings are processed by the self-attention neural network 306 of the encoder 320 to generate a set of hidden states. As described above, multi-head attention mechanism can be used to focus on different parts of the input sequence. The output from the self-attention neural network 306 is added to its input (residual connection) and then normalized at the addition and normalization layer 308.

Then, the feedforward neural network 310 is applied to each token independently. The feedforward neural network 310 includes fully connected layers with non-linear activation functions, allowing the model to capture complex interactions between tokens. The output from the feedforward neural network 310 is added its input (residual connection) and then normalized at the addition and normalization layer 312.

The decoder 340 uses the hidden states from the encoder 320 and its own previous output sequence to generate the next token in an autoregressive manner so that the sequential output is generated by attending to the previously generated tokens. Specifically, the output of the encoder 320 (input embeddings processed by the encoder 320) are fed to the encoder-decoder attention neural network 330 of the decoder 340, which allows the decoder 340 to attend to all words in the input sequence. As described above, the encoder-decoder attention neural network 330 can implement a multi-head attention mechanism, e.g., computing a weighted sum of all the encoded input vectors, with the most relevant vectors being attributed the highest weights.

The previous output sequence of the decoder 340 is first tokenized by the output embedding unit 322 to generate an output embedding for each token in the output sequence. Similarly, positional embedding 324 is added to the output embedding to retain information regarding the order of words in the output sequence.

The output embeddings are processed by the self-attention neural network 326 of the decoder 340 to generate a set of hidden states. The self-attention mechanism allows each token in the text output to attend to all tokens in the input sequence as well as all previous tokens in the output sequence. The output from the self-attention neural network 326 is added to its input (residual connection) and then normalized at the addition and normalization layer 328.

The encoder-decoder attention neural network 330 receives the output embeddings processed through the self-attention neural network 326 and the addition and normalization layer 328. Additionally, the encoder-decoder attention neural network 330 also receives the output from the addition and normalization layer 312 which represents input embeddings processed by the encoder 320. By considering both processed input embeddings and output embeddings, the output of the encoder-decoder attention neural network 330 represents an output embedding which takes into account both the input sequence and the previously generated outputs. As a result, the decoder 340 can generate the output sequence that is contextually aligned with the input sequence.

The output from the encoder-decoder attention neural network 330 is added to part of its input (residual connection), i.e., the output from the addition and normalization layer 328, and then normalized at the addition and normalization layer 332. The normalized output from the addition and normalization layer 332 is then passed through the feedforward neural network 334. The output of the feedforward neural network 334 is then added to its input (residual connection) and then normalized at the addition and normalization layer 336.

The processed output embeddings output by the decoder 340 are passed through the linear layer 342, which maps the high-dimensional output embeddings back to the size of the vocabulary, that is, it transforms the output embeddings into a space where each dimension corresponds to a word in the vocabulary. The softmax layer 344 then converts output of the linear layer 342 into probabilities, each of which corresponds to the likelihood of a particular word being the next word in the sequence. Finally, the LLM 300 samples an output token from the probability distribution generated by the softmax layer 344 (e.g., selecting the token with the highest probability), and this token is added to the sequence of generated tokens for the text output.

The steps described above are repeated for each new token until an end-of-sequence token is generated or a maximum length is reached. Additionally, if the encoder 320 and/or decoder 340 have multiple stacked layers, the steps performed by the encoder 320 and decoder 340 are repeated across each layer in the encoder 320 and the decoder 340 for generation of each new token.

### Example Feature Extractor

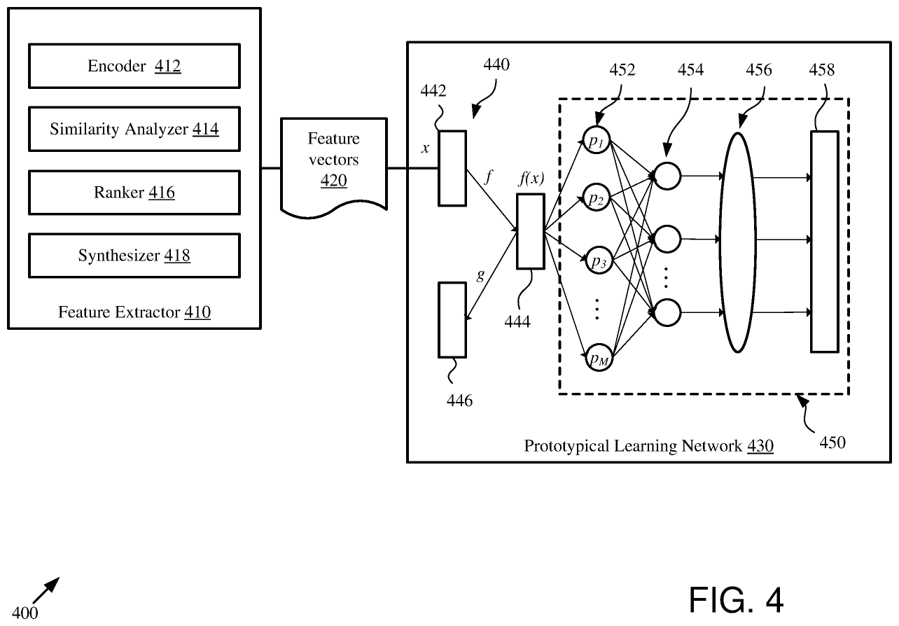

FIG. 4 is an example block diagram of a recommendation engine 400, which can be an example embodiment of the recommendation engine 160 used in the intelligent monitor class recommendation framework depicted in FIG. 1. As shown, the recommendation engine 400 includes a feature extractor 410 and a prototypical learning network (PLN) 430. The feature extractor 410 can be an example embodiment of the feature extractor 170.

The feature extractor 410 is configured to implement a series of preprocessing steps to extract feature vectors from a training data set (e.g., the training data set 150). These preprocessing steps can be performed by multiple modules included in the feature extractor 410. For example, the feature extractor 410 can include an encoder 412, a similarity analyzer 414, a ranker 416, and a synthesizer 418. Each of these modules can be implemented in software and/or hardware.

The encoder 412 is configured to perform one-hot encoding of input data, which can be service properties of a service or monitor classes associated with a service. If the input data is service properties of a service, the output of the encoder 412 is a one-hot encoded service property vector (with a predefined length) for that service. If the input data is monitor classes associated with a service, the output put of the encoder 412 is a one-hot encoded monitored class vector (with a predefined length) representing monitor classes associated with the service. Additional details of performing one-hot encoding by the encoder 412 are described further below.

The similarity analyzer 414 is configured to measure a similarity score between two services. More specifically, the similarity analyzer 414 can be used to measure a similarity score between two one-hot encoded service property vectors encoded for two different services. The resulting similarity score indicates how similar those two services are, e.g., in terms of dependencies and components. In some examples, the similarity score can be cosine similarity, which measures the cosine of the angle between two vectors, providing a similarity score between 0 and 1. Alternative methods to measure similarity score can also be used, such as based on measurement of Euclidean Distance, Jaccard Similarity, etc.

The ranker 416 is configured to rank the similarity scores measured by the similarity analyzer 414. For example, the similarity analyzer 414 measures similarity scores between a given service and multiple other services. These scores are then passed to the ranker 416, which ranks them in descending order. The top N services (where N is a positive integer, e.g., N can be 1, 2, 3, 4, 5, or more) with the highest similarity scores are selected as the most similar services to the given service.

The synthesizer 418 is configured to compose feature vectors 420 based on output of the encoder 412, similarity analyzer 414, and the ranker 416. Specifically, after identifying top N services for a given service, N feature vectors can be generated for the given service, each corresponding to one of the top N services. These N feature vectors can also be referred to as embeddings of the top N services. For each one of the top N services, a corresponding embedding can be generated by composing three parts into one feature vector: a similarity score, a one-hot encoded service property vector, and a one-hot encoded monitored class vector. For example, if the top three services for Service A are Service 1, Service 2, and Service 3, then the embeddings of the top three services for Service A can be represented by the following three feature vectors:
[similarity score for Service 1, one-hot encoded service property vector for Service 1, one-hot encoded monitored class vector for Service 1]
[similarity score for Service 2, one-hot encoded service property vector for Service 2, one-hot encoded monitored class vector for Service 2]
[similarity score for Service 3, one-hot encoded service property vector for Service 3, one-hot encoded monitored class vector for Service 3]

During the training phase, the feature vectors 420 can be provided as input to the PLN 430. For example, let us assume service properties from L services and the structured ontology generated from metadata of monitors for the L services are collected as a training data set (e.g., the training data set 150 of FIG. 1). For each given service among the L services, a similarity score can be calculated for each one of the remaining L-1 services, based on which the top N (where N<L) services that are most similar to the given service can be determined. Then, the embeddings of the top N services can be generated, as described above. Thus, a total of L×N feature vectors can be generated for the training.

Additionally, for each one of the L services, one or more labels of monitor classes can be provided to the PLN 430 as ground truth (which can also be referred to as “target monitor classes”) for training purposes. Because each given service has N feature vectors representing the embeddings of the top N services, the labels selected for the given service are paired with the each one of the N feature vectors. Using the above example, if “CPU” is a selected label (representing the CPU resource class) for Service A, then during training, the same label “CPU” serves as a ground truth when input of the PLN 430 is provided with each of the three feature vectors corresponding to Service 1, Service 2, and Service 3, respectively.

In some examples, the top N feature vectors for each service can be concatenated to form a composite feature vector so that the length of the composite feature vector is N times that of an individual feature vector. In such scenarios, a total of L composite feature vectors can be generated corresponding to the L services, respectively. These composite feature vectors can be provided as input to the PLN 430 for training. Similarly, for each one of the L services, one or more labels of monitor classes can be provided to the PLN 430 as ground truth for training purposes.

In some examples, a single label corresponding to one monitor class can be selected for each one of the L services. In this scenario, the PLN 430 is trained to generate a single label (that is, to predict an individual monitor class) for each service. In some examples, multiple labels representing multiple monitor classes can be selected for each one of the L services. In this scenario, the PLN 430 is trained to generate multiple labels (that is, to predict multiple monitor classes) for each service.

### Example One-Hot Encoding

The encoder 412 is configured to perform one-hot encoding of properties and/or monitor classes associated with a service.

As described above, each service can have one or more service properties, which can include (upstream and/or downstream) dependencies and/or (physical and/or logical) components. For the training data set, a predefined universal set of service properties can be constructed in a predetermined sequence. If a service has properties that matches some of the universal set of service properties, the corresponding elements in the one-hot encoded service property vector for the service are set to ones. The elements corresponding to other non-matched service properties are set to zeros. For example, if the universal set of service properties include 100 service properties, and Service A has only two service properties “data analytics service” and “facility” which respectively match two of the 100 service properties in the universal set, then the one-hot encoded service property vector for Service A would be a vector of 100 elements where only the positions corresponding to “data analytics service” and “facility” are set to one, and all other 98 elements are set to zero. In other words, the one-hot encoded service property vector provides a binary representation of the service properties of Service A in the context of the universal set of service properties.

Similarly, a universal set of predefined monitor classes (e.g., resource classes and/or PO classes) can be constructed in a predetermined sequence. If monitors for service monitor resources and/or metrics (e.g., in metadata) match some of the predefined monitor classes, then the corresponding elements in the one-hot encoded monitored class vector for the service are set to ones. The elements corresponding to other non-matched monitor classes are set to zeros. For example, if the universal set of predefined monitor classes include 13 resource classes and 9 PO classes (as described above), and Service A has a single monitor that monitors the size of unused RAM memory, then the one-hot encoded monitored class vector for Service A would be a vector of 22 elements where only the positions corresponding to the “Ram-memory” resource class and “Availability” PO class are set to one, and all other 20 elements are set to zero. In other words, the one-hot encoded monitored class vector provides a binary representation of the resource(s) and metric(s) monitored for Service A in the context of the universal set of monitor classes.

### Example Machine Learning Model

FIG. 4 also shows components of the PLN 430, which can be an example embodiment of the ML model 180.

The PLN 430 is a distance-based classifier in a low-dimensional learned feature space and can learn patterns from a training data set. As shown in FIG. 4, the architecture of PLN 430 has two main components: an autoencoder 440 and a prototype classification network 450 (also referred to as a “prototype classifier”).

The autoencoder 440 includes an encoder 442 and a decoder 446. The encoder 442 is configured to convert or encode the input signal x from a higher dimension (e.g., dimension p) to a lower dimension representation 444 (e.g., dimension q, where q<p), denoted as f: Rₚ→R_{q}. The decoder 446, on the other hand, is configured to invert conversions of the encoder 442 and reconstruct the original high-dimensional data from the lower dimensional representation 444 (i.e., f(x)) created by the encoder 442, effectively reversing the process of dimensionality reduction and denoted as g: R_{q}→Rₚ.

When the feature vectors described above are provided as input (x) to the PLN 430, the input dimension q is the length of the feature vectors. Similarly, when the composite feature vectors described above are provided as input (x) to the PLN 430, the input dimension q is the length of the composite feature vectors. Thus, the autoencoder 440 can be utilized to encode the feature vectors or composite feature vectors to a lower dimensional representation 444, based on which useful features can be learned by the prototype classification network 450 for prediction. Specifically, the encoded input f(x) can be used to produce a probability distribution over K classes through the prototype classification network 450.

The prototype classification network 450 includes three layers: a prototype layer 452 (denoted as p: [symbol] → [symbol] ), a fully connected layer 454 (denoted as w: [symbol] → [symbol] ), and a softmax layer 456 (denoted as s: [symbol] → [symbol] . The prototype classification network 450 learns M prototype vectors p₁, p₂, . . . , p_{M}∈R_{q} (each corresponds to a prototype unit) in the latent space, where M is a positive integer. The prototype layer 452 can compute the squared L2 distance between the encoded input z=f(x) and each of the M prototype vectors: p(z)=[∥z−p₁∥₂², ∥z−p₂∥₂², . . . , ∥z−p_{M}∥₂²]. The prototype unit corresponding to pⱼ executes the computation ∥z−pⱼ∥₂². The fully connected layer 454 computes weighted sums of these distances Wₚ(z), where W is a K×M weight matrix. These weighted sums are then normalized by the softmax layer 456 to output a probability distribution over the K classes.

Finally, an output layer 458 can generate one or more predicted classes that have the highest probability values among the K classes. For example, for a given input feature vector (or composite feature vector), one or more predicted monitor classes can be generated by the output layer 458. The predicted monitor classes can be resource classes, or PO classes, or both resource classes and PO classes.

The utilization of PLN 430 for monitor class prediction offers at least two benefits. First, the PLN 430 is capable of autonomously identifying pertinent features and prototypes that are indicative of each class. Second, the prototype vectors exist within the same realm as the encoded inputs, enabling the use of these vectors by feeding them into the decoder 446 and visualizing the learned prototypes. Specifically, for a predicted monitor class determined by the prototype classification network 450, a reconstructed feature vector can be generated (by the decoder 446) from a selected prototype vector, which has a smallest distance to the encoded feature vector among the M prototype vectors. This characteristic facilitates the interpretation of results and the display of key features underlying the provided recommendations, thereby enhancing the explainability for designers of service monitors and/or service providers.

In the training phase, the model parameters M (the number or prototypes) and K (the number of output classes) can be tuned to improve the classification performance (e.g., based on precision and recall or other metrics), or predefined. For example, M can range from 1 to n, wherein n is the number of data points in the training data set, and K can be 1 (e.g., for a single model class), 2 (e.g., for a single resource class and a single PO class), or more (e.g., based on the number of model classes derived from the structured ontology).

During training, some model parameters, e.g., the weights W associated with the fully connected layer 454 and the M prototype vectors, can be iteratively updated. Specifically, let us assume that the training data set generates a total of F feature vectors (or composite feature vectors), and each service has one or more labels of monitor classes (ground truth), as described above. Each one of the F feature vectors (or composite feature vectors) can be provided as an input (x) to the PLN 430, and one or more predicted monitor classes can be generated as an output of the PLN 430. The predicted monitor classes can be compared with the ground truth of the corresponding service to determine a difference. The weights W and/or the M prototype vectors of the prototype classification network 450 can then be updated at least based in part on the difference. For example, using the determined difference, gradients can be computed using backward propagation, and then model parameters can be updated according to the gradients. Training can repeat in training iterations for different batches (subsets) of input feature vectors (or composite feature vectors) in the training data set, for an epoch (a pass through the data in the training data set). The overall training process can repeat for multiple epochs until a stopping criterion is satisfied (e.g., the determined difference is below a threshold, or the model parameters have converged).

### Example Inference Using the Machine Learning Model

Once training of the PLN 430 is complete, it can be used for inference, i.e., to predict monitor classes for a given service. The predicted monitor classes can then be recommended to be included in one or more monitors for the given service. The given service can be a new service that was previously not involved in training the PLN 430 or an existing service that was previously used in training the PLN 430. In the following, a new service is used as an example to illustrate the inference process, although it should be understood that the same inference process can be applied for an existing service (e.g., for verification or updating after a period of time has elapsed since training).

To recommend monitors for a new service, service properties (e.g., dependencies and components) of the new service can be collected. Then, N feature vectors for the new service can be determined (e.g., by the feature extractor 410) based on the service properties of the new service, similar to the feature vector extraction approach employed in the training phase described above.

Specifically, top N services among the plurality of services used for training the PLN 430 can be determined. To determine the top N services among the plurality of services, a one-hot encoded service property vector representing the new service can be generated (e.g., using the encoder 412). For each given service of the plurality of services, a similarity score between a one-hot encoded service property vector of the new service and a one-hot encoded service property vector of the given service can be calculated (e.g., using the similarity analyzer 414). Then, the top N services among the plurality of services that have the highest similarity scores can be determined (e.g., using the ranker 416).

Next, N feature vectors for the new service, or embeddings of the top N services, can be generated. To generate the embeddings, for a given top service of the top N services, a one-hot encoded monitored class vector representing monitor classes associated with the given top service can be generated. Then, a corresponding feature vector for the new service can be composed to include a corresponding similarity score of the given top service, the one-hot encoded service property vector of the given top service, and the one-hot encoded monitored class vector of the given top service.

The determined N feature vectors for the new service can be provided to the trained PLN 430, which can predict one or more monitor classes to be included in a monitor for the new service. Once a recommendation of the monitor is given for the new service, the original dimension of the nearest prototype can be viewed using the decoder 446, to provide explainability and make the recommendation more convincing to the service providers, as described above.

As described above, the PLN 430 can be trained using either composite or individual feature vectors as model input. If the PLN 430 was previously trained using composite feature vectors as model input, the determined N feature vectors for the new service can be concatenated to form a new composite feature vector, which is provided as an input (x) to the PLN 430. The output of the PLN 430 will be one or more predicted monitor classes corresponding to the new composite feature vector. On the other hand, if the PLN 430 was previously trained using individual feature vectors as model input, each of the determined N feature vectors for the new service can be selected as a separate input (x) to the PLN 430, and the PLN 430 will generate an individual output (i.e., one or more predicted monitor classes) corresponding to the selected feature vector. Then, N individual outputs respectively corresponding to the N feature vectors can be consolidated to generate a final output for the new service. The consolidation can be done in several ways. For instance, the final output could include the monitor classes that appear most frequently among the individual outputs, determined through a voting mechanism. Alternatively, the final output could include monitor classes whose sum of classification probabilities, based on the output of the softmax layer 456, exceeds a predefined threshold. Other consolidation methods can also be used to generate the final output from the individual outputs for the new service.

### Example Overall Method for Training Machine Learning Model

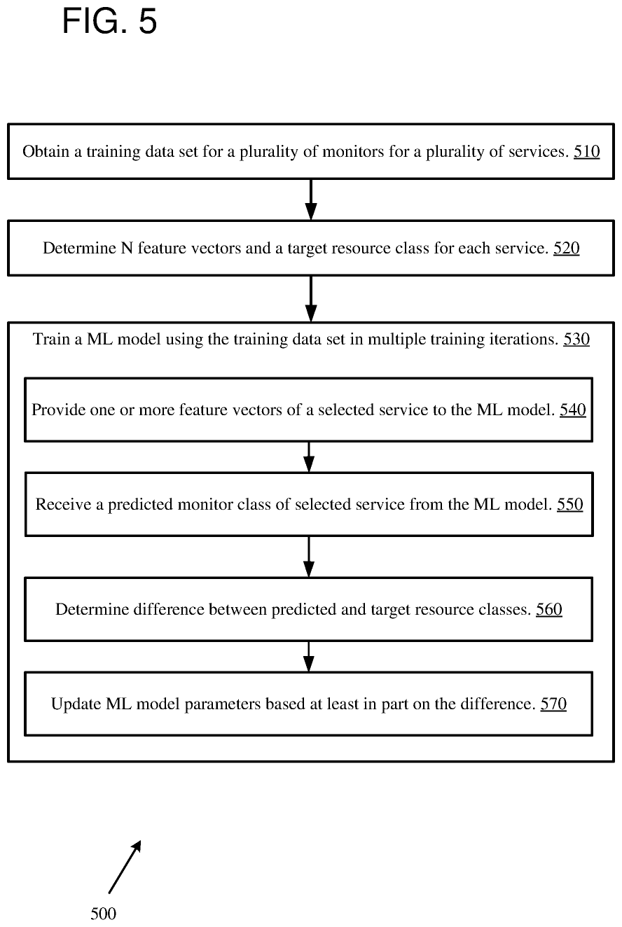

FIG. 5 is a flowchart illustrating an example overall method 500 for training a ML model (e.g., the ML model 180 or the PLN 430). The method 500 can be performed, e.g., by the computing system 100 of FIG. 1.

At step 510, a training data set for a plurality of monitors for a plurality of services is obtained. As described above, the training data set include service properties for each service of the plurality of services and metadata for each monitor of the plurality of monitors. The service properties for a given service can include dependencies (e.g., upstream dependencies and downstream dependencies) and components (e.g., physical components and logical components). The metadata for a given monitor of the plurality of monitors defines one or more resources and metrics being monitored for a corresponding service among the plurality of services. Monitor classes can be derived from the metadata for the given monitor, e.g., by leveraging a generative AI or LLM model, as illustrated in FIG. 2. For example, the resources can be categorized into one or more resource classes, and metrics can be categorized into one or more PO classes.

At step 520, N feature vectors (Nis a positive integer) and a target monitor class can be determined for each service of the plurality of services based on the training data set. As described above with reference to FIG. 4, the N feature vectors can be generated by the feature extractor 410, which perform a series of operations including one-hot encoding of service properties and monitor classes (e.g., by the encoder 412), measuring similarity scores (e.g., by the similarity analyzer 414), ranking of similarity scores (e.g., by the ranker 416), and composing of feature vectors (e.g., by the synthesizer 418). A monitor class associated with a given monitor for a given service can be selected as the target monitor class (or label, ground truth) for the given service.

At step 530, a ML model can be trained in multiple training iterations using the training data set. In a given training iteration of the multiple training iterations, the training can include multiple steps 540, 550, 560, and 570.

At step 540, one or more of the N feature vectors of a selected service of the plurality of services can be provided to the ML model. As described above, in some cases, each individual one of the N feature vectors of the selected service can be provided as an input to the ML model. Alternatively, the N feature vectors of the selected service can be first concatenated to form a composite feature vector, which is then provided as an input to the ML model.

At step 550, a predicted monitor class of the selected service can be received from the ML model. The predicted monitor class can be generated (e.g., by the output of the prototype classification network 450) based on the input received by the ML model.

At step 560, a difference between the predicted monitor class and the target monitor class for the selected service can be determined.

Then at step 570, one or more parameters of the ML model (e.g., weights and/or the prototype vectors of the prototype classification network 450) can be updated based at least in part on the difference.

The method 500 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “send” can also be described as “receive” from a different perspective.

### Example Overall Method for Predicting Monitor Classes

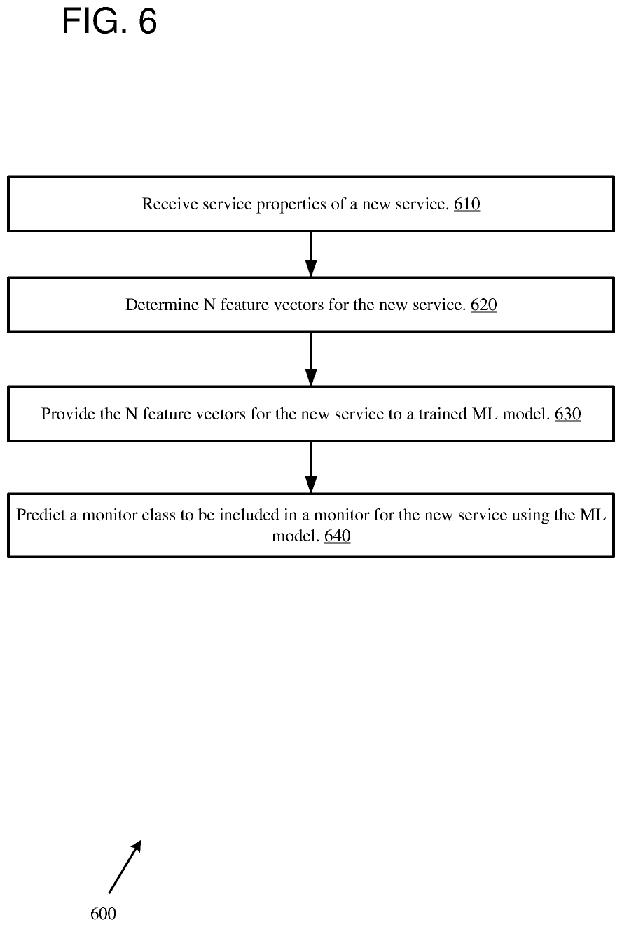

FIG. 6 is a flowchart illustrating an example overall method 600 for using a previously trained ML model (e.g., the ML model 180 or the PLN 430) to perform inference, e.g., to recommend a monitor for a new service (or an existing service). The method 600 can be performed, e.g., by the computing system 100 of FIG. 1.

At step 610, service properties of a new service are received. Similar to the services in training, the service properties for the new service can include dependencies (e.g., upstream dependencies and downstream dependencies) and components (e.g., physical components and logical components) of the new service.

At step 620, N feature vectors for the new service can be determined based on the service properties of the new service. Likewise, the N feature vectors can be generated by the feature extractor 410, as described above.

At step 630, the N feature vectors for the new service can be provided to a trained ML model. As described above, if the ML model was previously trained using composite feature vectors as model input, the determined N feature vectors for the new service can be concatenated to form a new composite feature vector, which is provided as an input to the ML model. On the other hand, if the ML model was previously trained using individual feature vectors as model input, each of the determined N feature vectors for the new service can be selected as a separate input to the ML model.

At step 640, a monitor class can be predicted using the trained ML model, and the predicted monitor class can be recommended to be included in a monitor for the new service. As described above, if a new composite feature vector is provided as an input to the ML model, the output of the ML model will be the predicted monitor class corresponding to the new composite feature vector. On the other hand, if each individual feature vector is provided as an input to the ML model, the ML model will generate an individual output corresponding to that feature vector, and N individual outputs respectively corresponding to the N feature vectors can be consolidated to generate a final output or predicted monitor class for the new service.

### Example Advantages

The disclosed technologies offer several technical advantages that address the challenges of current monitoring processes (e.g., incomplete coverage, redundancy, etc.).

At the outset, disclosed herein is an intelligent monitor class recommendation framework, which, for the first time, provides a strategic and proactive approach to creating and managing service monitors. This framework ensures that monitoring practices are consistent, efficient, and effective, thereby overcoming the limitations of the traditional trial-and-error approach.

Specifically, the technologies described herein employ a machine learning model (e.g., a prototypical learning network) that is trained iteratively to predict a monitor class using data collected from a set of monitors for various services. This technical feature enables the trained machine learning model to recommend a monitor class in a monitor for a new service, thus facilitating a more targeted and efficient monitoring process.

Additionally, the disclosed technologies can construct N feature vectors for a given service based on top N services with similar service properties. Each one of the N feature vectors includes a similarity score, a one-hot encoded service property vector, and a one-hot encoded monitored classes vector for a corresponding top service. This technical feature allows the machine learning model to learn associations between services and generate prototypes that represent clusters of similar services. As a result, similar monitor classes can be predicted for services with similar properties, enhancing the precision of the monitoring process.

Further, the disclosed technologies leverage a generative AI model to generate monitor classes based on metadata of the monitors. This technical feature enables accurate and efficient categorization of resources and metrics defined in the metadata of the monitors into one or more resource and PO classes. This approach can filter out noise (such as irrelevant information or inconsistencies) while analyzing functionally related signals in the metadata, thereby improving the overall reliability and performance of the monitor class recommendation system.

### Example Computing Systems

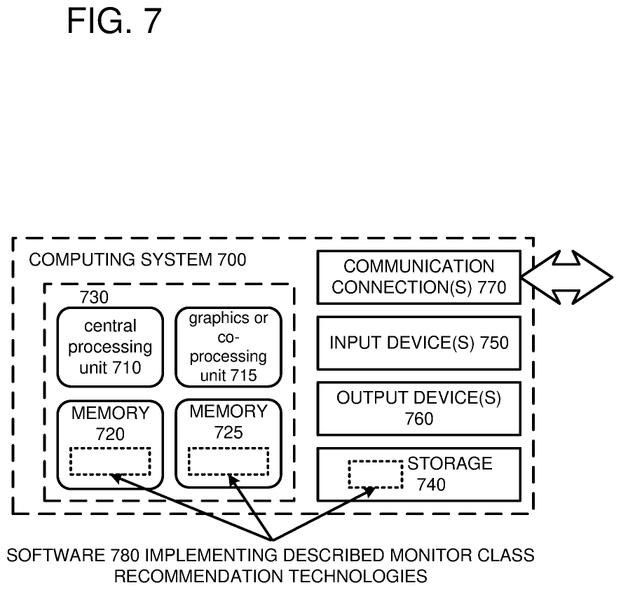

FIG. 7 depicts an example of a suitable computing system 700 in which the described innovations can be implemented. The computing system 700 is not intended to suggest any limitation as to scope of use or functionality of the present disclosure, as the innovations can be implemented in diverse computing systems.

With reference to FIG. 7, the computing system 700 includes one or more processing units 710, 715 and memory 720, 725. In FIG. 7, this basic configuration 730 is included within a dashed line. The processing units 710, 715 can execute computer-executable instructions, such as for implementing the features described in the examples herein (e.g., the methods 500, 600). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 7 shows a central processing unit 710 as well as a graphics processing unit or co-processing unit 715. The tangible memory 720, 725 can be volatile memory (e.g., registers, cache, RAM), non-volatile memory (e.g., ROM, EEPROM, flash memory, etc.), or some combination of the two, accessible by the processing unit(s) 710, 715. The memory 720, 725 can store software 780 implementing one or more innovations described herein, in the form of computer-executable instructions suitable for execution by the processing unit(s) 710, 715.

More generally, the term “processor” refers generically to any device that can process computer-executable instructions and may include a microprocessor, microcontroller, programmable logic device, digital signal processor, and/or other computational device. A processor may be a processing core of a CPU, other general-purpose unit, or GPU. A processor may also be a specific-purpose processor implemented using, for example, an ASIC or a field-programmable gate array (“FPGA”). A “processor system” is a set of one or more processors, which can be located together or distributed across a network.

A computing system 700 can have additional features. For example, the computing system 700 can include storage 740, one or more input devices 750, one or more output devices 760, and one or more communication connections 770, including input devices, output devices, and communication connections for interacting with a user. An interconnection mechanism (not shown) such as a bus, controller, or network can interconnect the components of the computing system 700. Typically, operating system software (not shown) can provide an operating environment for other software executing in the computing system 700, and coordinate activities of the components of the computing system 700.

The tangible storage 740 can be removable or non-removable, and includes magnetic disks, magnetic tapes or cassettes, CD-ROMs, DVDs, or any other medium which can be used to store information in a non-transitory way and which can be accessed within the computing system 700. The storage 740 can store instructions for the software implementing one or more innovations described herein.

The input device(s) 750 can be an input device such as a keyboard, mouse, pen, or trackball, a voice input device, a scanning device, touch device (e.g., touchpad, display, or the like) or another device that provides input to the computing system 700. The output device(s) 760 can be a display, printer, speaker, CD-writer, or another device that provides output from the computing system 700.

The communication connection(s) 770 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

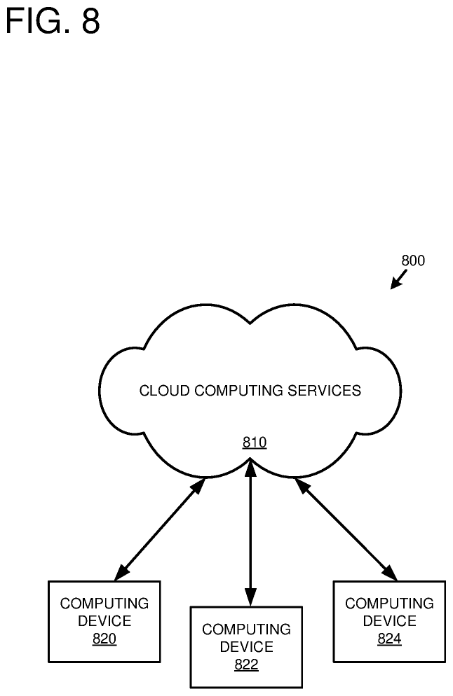

FIG. 8 depicts an example cloud computing environment 800 in which the described technologies can be implemented, including, e.g., the system 100 and other systems herein. The cloud computing environment 800 can include cloud computing services 810. The cloud computing services 810 can comprise various types of cloud computing resources, such as computer servers, data storage repositories, networking resources, etc. The cloud computing services 810 can be centrally located (e.g., provided by a facility of a business or organization) or distributed (e.g., provided by various computing resources located at different locations, such as different facilities and/or located in different cities or countries).

The cloud computing services 810 can be utilized by various types of computing devices (e.g., client computing devices), such as computing devices 820, 822, and 824. For example, the computing devices (e.g., 820, 822, and 824) can be computers (e.g., desktop or laptop computers), mobile devices (e.g., tablet computers or smart phones), or other types of computing devices. For example, the computing devices (e.g., 820, 822, and 824) can utilize the cloud computing services 810 to perform computing operations (e.g., data processing, data storage, and the like).

In practice, cloud-based, on-premises-based, or hybrid scenarios can be supported.

### Example Implementations

In any of the examples herein, a software application (or “application”) can take the form of a single application or a suite of a plurality of applications, whether offered as a service (SaaS), in the cloud, on premises, on a desktop, mobile device, wearable, or the like.

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

In any of the examples described herein, an operation performed in runtime means that the operation can be completed in real time or with negligible processing latency (e.g., the operation can be completed within 1 second, etc.).

### Example Clauses

Any of the following example clauses can be implemented.

Clause 1. A computer-implemented method comprising: obtaining a training data set for a plurality of services and for a plurality of monitors for the plurality of services, wherein the training data set comprises service properties for each service of the plurality of services and metadata for each monitor of the plurality of monitors, wherein the metadata for a given monitor of the plurality of monitors defines one or more resources and metrics being monitored for a corresponding service among the plurality of services; determining N feature vectors and a target monitor class for each service of the plurality of services based on the training data set, wherein N is a positive integer; and training a machine learning model in multiple training iterations using the training data set, wherein the training comprises, in a given training iteration of the multiple training iterations: providing, to the machine learning model, one or more of the N feature vectors of a selected service of the plurality of services; receiving, from the machine learning model, a predicted monitor class of the selected service; determining a difference between the predicted monitor class and the target monitor class for the selected service; and updating one or more parameters of the machine learning model based at least in part on the difference.

Clause 2. The method of clause 1, wherein the determining N feature vectors for a specific service of the plurality of services comprises: determining top N services among remaining services, wherein the remaining services are among the plurality of services that are different from the specific service; and generating embeddings of the top N services.

Clause 3. The method of clause 2, wherein the determining top N services among remaining services comprises: generating one-hot encoded service property vectors representing respective service properties for the plurality of services; for each one of the remaining services, measuring a similarity score between a one-hot encoded service property vector of the specific service and a one-hot encoded service property vector of the remaining service; and identifying the top N services among the remaining services based on the similarity scores.

Clause 4. The method of clause 3, wherein generating embeddings of the top N services comprises, for a given top service of the top N services: generating a one-hot encoded monitored class vector representing resources and metrics being monitored for the given top service; and composing a corresponding feature vector for the specific service including a corresponding similarity score of the given top service, the one-hot encoded service property vector of the given top service, and the one-hot encoded monitored class vector of the given top service.

Clause 5. The method of any one of clauses 1-4, further comprising: recommending a new monitor for a new service using the trained machine learning model, wherein the recommending comprises: determining N feature vectors for the new service; providing the N feature vectors for the new service to the trained machine learning model; and predicting a monitor class to be included in the new monitor using the trained machine learning model.

Clause 6. The method of any one of clauses 1-5, wherein the machine learning model comprises a prototypical learning network.

Clause 7. The method of clause 6, wherein the prototypical learning network comprises an autoencoder and a prototype classifier, wherein the autoencoder comprises an encoder configured to convert a received feature vector into an encoded feature vector, wherein the encoded feature vector has a lower dimension than the received feature vector, and wherein the prototype classifier is configured to determine the predicted monitor class based on the encoded feature vector.

Clause 8. The method of clause 7, wherein the prototype classifier comprises a prototype layer, a fully connected layer, and a softmax layer, wherein the updating one or more parameters of the machine learning model comprises updating one or more of: M prototype vectors included in the prototype layer, wherein M is a positive integer; and weights associated with the fully connected layer.

Clause 9. The method of clause 8, further comprising: for the predicted monitor class determined by the prototype classifier, generating a reconstructed feature vector from a selected prototype vector, wherein the selected prototype vector has a smallest distance to the encoded feature vector among the M prototype vectors, wherein the generating the reconstructed feature vector uses a decoder configured to invert conversions of the encoder, and wherein the reconstructed feature vector has the same dimension as the received feature vector.

Clause 10. The method of any one of clauses 1-9, wherein the service properties for a given service, among the plurality of services, are selected from a universal set of predefined service properties, and wherein the universal set of predefined service properties comprises one or more predefined service dependencies and one or more predefined service components.

Clause 11. The method of any one of clauses 1-10, further comprising: for each monitor of the plurality of monitors, classifying the one or more resources and metrics defined in the metadata of the monitor, wherein the classifying the one or more resources and metrics comprises: prompting a generative artificial intelligence model to generate a description of the monitor based on the metadata of the monitor; and prompting the generative artificial intelligence model to categorize, based on the description of the monitor, the one or more resources and metrics defined in the metadata of the monitor into one or more monitor classes selected from a set of predefined monitor classes.

Clause 12. A computing system comprising: memory; a processor system coupled to the memory; and one or more computer readable storage media storing instructions that, when loaded into the memory, cause the processor system to perform operations comprising: receiving service properties of a new service; determining N feature vectors for the new service based on the service properties of the new service, wherein N is a positive integer; providing the N feature vectors for the new service to a trained machine learning model; and predicting a monitor class to be included in a monitor for the new service using the trained machine learning model.

Clause 13. The computing system of clause 12, wherein the determining N feature vectors for the new service comprises: determining top N services among a plurality of services used for training the machine learning model; and generating embeddings of the top N services.

Clause 14. The computing system of clause 13, wherein the determining the top N services among the plurality of services comprises: generating one-hot encoded service property vectors representing respective service properties for the plurality of services and the new service; for each given service of the plurality of services, measuring a similarity score between a one-hot encoded service property vector of the new service and a one-hot encoded service property vector of the given service; identifying the top N services among the plurality of services based on the similarity scores.

Clause 15. The computing system of clause 14, wherein the generating embeddings of the top N services comprises, for a given top service of the top N services: generating a one-hot encoded monitored class vector representing resources and metrics being monitored for the given top service; and composing a corresponding feature vector for the new service including a corresponding similarity score of the given top service, the one-hot encoded service property vector of the given top service, and the one-hot encoded monitored class vector of the given top service.

Clause 16. The computing system of any one of clauses 12-15, wherein the operations further comprise training the machine model, wherein the training comprises: obtaining a training data set for a plurality of services and for a plurality of monitors for the plurality of services, wherein the training data set comprises service properties for each service of the plurality of services and metadata for each monitor of the plurality of monitors, wherein the metadata for a given monitor of the plurality of monitors defines one or more resources and metrics being monitored for a corresponding service among the plurality of services; determining N feature vectors and a target resource class for each service of the plurality of services based on the training data set; and in a given training iteration of multiple training iterations: providing, to the machine learning model, one or more of the N feature vectors of a selected service of the plurality of services; receiving, from the machine learning model, a predicted monitor class of the selected service; determining a difference between the predicted monitor class and the target monitor class for the selected service; and updating one or more parameters of the machine learning model based at least in part on the difference.

Clause 17. The computing system of clause 16, wherein the machine learning model comprises a prototypical learning network, wherein the prototypical learning network comprises an autoencoder and a prototype classifier, wherein the autoencoder comprises an encoder configured to convert a received feature vector into an encoded feature vector, wherein the encoded feature vector has a lower dimension than the received feature vector, and wherein the prototype classifier is configured to determine the predicted monitor class based on the encoded feature vector.

Clause 18. The computing system of clause 17, wherein the prototype classifier comprises a prototype layer, a fully connected layer, and a softmax layer, wherein the updating one or more parameters of the machine learning model comprises updating one or more of: M prototype vectors included in the prototype layer, wherein M is a positive integer; and weights associated with the fully connected layer.

Clause 19. The computing system of any one of clauses 16-18, wherein the training further comprises: for each monitor of the plurality of monitors, classifying the one or more resources and metrics defined in the metadata of the monitor, wherein the classifying the one or more resources and metrics comprises: prompting a generative artificial intelligence model to generate a description of the monitor based on the metadata of the monitor; and prompting the generative artificial intelligence model to categorize, based on the description of the monitor, the one or more resources and metrics defined in the metadata of the monitor into one or more monitor classes selected from a set of predefined monitor classes.

Clause 20. One or more computer-readable media having encoded thereon computer-executable instructions causing one or more processors to perform a method, the method comprising: obtaining a training data set for a plurality of services and for a plurality of monitors for the plurality of services, wherein the training data set comprises service properties for each service of the plurality of services and metadata for each monitor of the plurality of monitors, wherein the metadata for a given monitor of the plurality of monitors defines one or more resources and metrics being monitored for a corresponding service among the plurality of services; determining N feature vectors and a target monitor class for each service of the plurality of services based on the training data set, wherein N is a positive integer; training a machine learning model in multiple training iterations using the training data set, wherein the training comprises, in a given training iteration of the multiple training iterations: providing, to the machine learning model, one or more of the N feature vectors of a selected service of the plurality of services; receiving, from the machine learning model, a predicted monitor class of the selected service; determining a difference between the predicted monitor class and the target monitor class for the selected service; and updating one or more parameters of the machine learning model based at least in part on the difference; and recommending a new monitor for a new service using the trained machine learning model, wherein the recommending comprises: determining N feature vectors for the new service; providing the N feature vectors for the new service to the trained machine learning model; and predicting a monitor class to be included in the new monitor using the trained machine learning model.

### Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
obtaining a training data set for a plurality of services and for a plurality of monitors for the plurality of services, wherein the training data set comprises service properties for each service of the plurality of services and metadata for each monitor of the plurality of monitors, wherein the metadata for a given monitor of the plurality of monitors defines one or more resources and metrics being monitored for a corresponding service among the plurality of services;
determining N feature vectors and a target monitor class for each service of the plurality of services based on the training data set, wherein N is a positive integer; and
training a machine learning model in multiple training iterations using the training data set, wherein the training comprises, in a given training iteration of the multiple training iterations:
providing, to the machine learning model, one or more of the N feature vectors of a selected service of the plurality of services;
receiving, from the machine learning model, a predicted monitor class of the selected service;
determining a difference between the predicted monitor class and the target monitor class for the selected service; and
updating one or more parameters of the machine learning model based at least in part on the difference.

2. The method of claim 1, wherein the determining N feature vectors for a specific service of the plurality of services comprises:
determining top N services among remaining services, wherein the remaining services are among the plurality of services that are different from the specific service; and
generating embeddings of the top N services.

3. The method of claim 2, wherein the determining top N services among remaining services comprises:
generating one-hot encoded service property vectors representing respective service properties for the plurality of services;
for each one of the remaining services, measuring a similarity score between a one-hot encoded service property vector of the specific service and a one-hot encoded service property vector of the remaining service; and
identifying the top N services among the remaining services based on the similarity scores.

4. The method of claim 3, wherein generating embeddings of the top N services comprises, for a given top service of the top N services:
generating a one-hot encoded monitored class vector representing resources and metrics being monitored for the given top service; and
composing a corresponding feature vector for the specific service including a corresponding similarity score of the given top service, the one-hot encoded service property vector of the given top service, and the one-hot encoded monitored class vector of the given top service.

5. The method of claim 1, further comprising:
recommending a new monitor for a new service using the trained machine learning model, wherein the recommending comprises:
determining N feature vectors for the new service;
providing the N feature vectors for the new service to the trained machine learning model; and
predicting a monitor class to be included in the new monitor using the trained machine learning model.

6. The method of claim 1, wherein the machine learning model comprises a prototypical learning network.

7. The method of claim 6, wherein the prototypical learning network comprises an autoencoder and a prototype classifier,
wherein the autoencoder comprises an encoder configured to convert a received feature vector into an encoded feature vector, wherein the encoded feature vector has a lower dimension than the received feature vector, and
wherein the prototype classifier is configured to determine the predicted monitor class based on the encoded feature vector.

8. The method of claim 7, wherein the prototype classifier comprises a prototype layer, a fully connected layer, and a softmax layer, wherein the updating one or more parameters of the machine learning model comprises updating one or more of:
M prototype vectors included in the prototype layer, wherein M is a positive integer; and
weights associated with the fully connected layer.

9. The method of claim 8, further comprising:
for the predicted monitor class determined by the prototype classifier, generating a reconstructed feature vector from a selected prototype vector, wherein the selected prototype vector has a smallest distance to the encoded feature vector among the M prototype vectors,
wherein the generating the reconstructed feature vector uses a decoder configured to invert conversions of the encoder, and wherein the reconstructed feature vector has the same dimension as the received feature vector.

10. The method of claim 1, wherein the service properties for a given service, among the plurality of services, are selected from a universal set of predefined service properties, and wherein the universal set of predefined service properties comprises one or more predefined service dependencies and one or more predefined service components.

11. The method of claim 1, further comprising:
for each monitor of the plurality of monitors, classifying the one or more resources and metrics defined in the metadata of the monitor, wherein the classifying the one or more resources and metrics comprises:
prompting a generative artificial intelligence model to generate a description of the monitor based on the metadata of the monitor; and
prompting the generative artificial intelligence model to categorize, based on the description of the monitor, the one or more resources and metrics defined in the metadata of the monitor into one or more monitor classes selected from a set of predefined monitor classes.

12. A computing system comprising:
memory;
a processor system coupled to the memory; and
one or more computer readable storage media storing instructions that, when loaded into the memory, cause the processor system to perform operations comprising:
receiving service properties of a new service;
determining N feature vectors for the new service based on the service properties of the new service, wherein N is a positive integer;
providing the N feature vectors for the new service to a trained machine learning model; and
predicting a monitor class to be included in a monitor for the new service using the trained machine learning model.

13. The computing system of claim 12, wherein the determining N feature vectors for the new service comprises:
determining top N services among a plurality of services used for training the machine learning model; and
generating embeddings of the top N services.

14. The computing system of claim 13, wherein the determining the top N services among the plurality of services comprises:
generating one-hot encoded service property vectors representing respective service properties for the plurality of services and the new service;
for each given service of the plurality of services, measuring a similarity score between a one-hot encoded service property vector of the new service and a one-hot encoded service property vector of the given service;
identifying the top N services among the plurality of services based on the similarity scores.

15. The computing system of claim 14, wherein the generating embeddings of the top N services comprises, for a given top service of the top N services:
generating a one-hot encoded monitored class vector representing resources and metrics being monitored for the given top service; and
composing a corresponding feature vector for the new service including a corresponding similarity score of the given top service, the one-hot encoded service property vector of the given top service, and the one-hot encoded monitored class vector of the given top service.

16. The computing system of claim 12, wherein the operations further comprise training the machine model, wherein the training comprises:
obtaining a training data set for a plurality of services and for a plurality of monitors for the plurality of services, wherein the training data set comprises service properties for each service of the plurality of services and metadata for each monitor of the plurality of monitors, wherein the metadata for a given monitor of the plurality of monitors defines one or more resources and metrics being monitored for a corresponding service among the plurality of services;
determining N feature vectors and a target resource class for each service of the plurality of services based on the training data set; and
in a given training iteration of multiple training iterations:
providing, to the machine learning model, one or more of the N feature vectors of a selected service of the plurality of services;
receiving, from the machine learning model, a predicted monitor class of the selected service;
determining a difference between the predicted monitor class and the target monitor class for the selected service; and
updating one or more parameters of the machine learning model based at least in part on the difference.

17. The computing system of claim 16, wherein the machine learning model comprises a prototypical learning network,
wherein the prototypical learning network comprises an autoencoder and a prototype classifier,
wherein the autoencoder comprises an encoder configured to convert a received feature vector into an encoded feature vector, wherein the encoded feature vector has a lower dimension than the received feature vector, and
wherein the prototype classifier is configured to determine the predicted monitor class based on the encoded feature vector.

18. The computing system of claim 17, wherein the prototype classifier comprises a prototype layer, a fully connected layer, and a softmax layer, wherein the updating one or more parameters of the machine learning model comprises updating one or more of:
M prototype vectors included in the prototype layer, wherein M is a positive integer; and
weights associated with the fully connected layer.

19. The computing system of claim 16, wherein the training further comprises:
for each monitor of the plurality of monitors, classifying the one or more resources and metrics defined in the metadata of the monitor, wherein the classifying the one or more resources and metrics comprises:
prompting a generative artificial intelligence model to generate a description of the monitor based on the metadata of the monitor; and
prompting the generative artificial intelligence model to categorize, based on the description of the monitor, the one or more resources and metrics defined in the metadata of the monitor into one or more monitor classes selected from a set of predefined monitor classes.

20. One or more computer-readable media having encoded thereon computer-executable instructions causing one or more processors to perform a method, the method comprising:
obtaining a training data set for a plurality of services and for a plurality of monitors for the plurality of services, wherein the training data set comprises service properties for each service of the plurality of services and metadata for each monitor of the plurality of monitors, wherein the metadata for a given monitor of the plurality of monitors defines one or more resources and metrics being monitored for a corresponding service among the plurality of services;
determining N feature vectors and a target monitor class for each service of the plurality of services based on the training data set, wherein N is a positive integer;
training a machine learning model in multiple training iterations using the training data set, wherein the training comprises, in a given training iteration of the multiple training iterations:
providing, to the machine learning model, one or more of the N feature vectors of a selected service of the plurality of services;
receiving, from the machine learning model, a predicted monitor class of the selected service;
determining a difference between the predicted monitor class and the target monitor class for the selected service; and
updating one or more parameters of the machine learning model based at least in part on the difference; and
recommending a new monitor for a new service using the trained machine learning model, wherein the recommending comprises:
determining N feature vectors for the new service;
providing the N feature vectors for the new service to the trained machine learning model; and
predicting a monitor class to be included in the new monitor using the trained machine learning model.
